(19) United States
(12) Patent Application Publication
(10) Pub. No.: US 2006/0008730 A1
(43) Pub. Date: Jan. 12, 2006

(54) Monomers for photoresists bearing acid-labile groups of reduced optical density

(76) Inventors: Michael Van Der Puy, Amherst, NY (US); Haridasan K. Nair, Williamsville, NY (US); Jingji Ma, West Seneca, NY (US); David Nalewajek, West Seneca, NY (US); Andrew J. Poss, Kenmore, NY (US); Leonard M. Stachura, Hamburg, NY (US); Lawrence A. Ford, Buffalo, NY (US); Dennis M. Lavery, Springville, NY (US)

Correspondence Address: COLLEEN D. SZUCH;Honeywell International Inc. - Patent Department, 101 Columbia Road, Morristown, NJ, 07962, US

(21) Appl. No.: 10/888,732

(22) Filed: Jul. 9, 2004

(51) Int. Cl. G03C 1/492

(52) U.S. Cl. 430/270.1

(57) ABSTRACT

Monomers and polymers useful for forming photoresists are provided. More particularly, photoresists, as well as monomers and polymers for photoresists useful in micro-lithography, specifically monomers bearing acid-labile groups of reduced optical density. The resulting photoresists exhibit improved transparency to 157 nm light. The photoresist compositions are composed of a mixture of at least one water insoluble, acid decomposable polymer which is prepared from at least one monomeric unit which comprises an acid labile group of the formula —OC(CH₃)₂CF₃ and which is substantially transparent to ultraviolet radiation at a wavelength of about 157 nm and at least one photoacid generator capable of generating an acid upon exposure to sufficient activating energy at a wavelength of about 157 nm.

### BACKGROUND OF THE INVENTION

The invention relates to monomers and polymers useful for forming photoresists. More particularly, the invention pertains to photoresists, as well as monomers and polymers for photoresists useful in micro-lithography, specifically monomers bearing acid-labile groups of reduced optical density. The resulting photoresists exhibit improved transparency to radiation at a wavelength of 157 nm.

Photoresists are organic polymeric materials that are used in a wide variety of applications, including lithographic imaging materials for semiconductor applications, particularly microlithography processes for making miniature electronic components. Generally in these processes a thin film coating of a photoresist composition is applied to a substrate, such as silicon wafers used for making integrated circuits. Any solvent in the photoresist composition is then evaporated to fix the coating onto the substrate. The photoresist coated on the substrate is next subjected to an imagewise exposure to radiation. Visible light, ultraviolet (UV) light, electron beam and X-ray radiant energy are radiation types commonly used today in microlithographic processes.

There are two types of photoresist compositions, negative-working and positive-working. When negative-working photoresist compositions are exposed imagewise to radiation, the areas of the resist composition exposed to the radiation become less soluble to a developer solution (e.g. a cross-linking reaction occurs) while the unexposed areas of the photoresist coating remain relatively soluble to such a solution. Thus, treatment of an exposed negative-working resist with a developer causes removal the non-exposed areas of the photoresist coating and the creation of a negative image in the coating, thereby uncovering a desired portion of the underlying substrate surface on which the photoresist composition was deposited.

Alternately, when positive-working photoresist compositions are exposed imagewise to radiation, those areas of the photoresist composition exposed to the radiation become more soluble to the developer solution while those areas not exposed remain relatively insoluble to the developer solution. More specifically, one type of a positive-working system, the radiation causes a photoacid component of the photoresist to produce an acid. The presence of this acid causes the hydrolysis of an acid labile group present in another component of the photoresist, producing hydrolysis products that are soluble in an aqueous base. After this imagewise exposure, the coated substrate is treated with a aqueous base developer solution to dissolve and remove the radiation exposed areas of the photoresist. Thus, treatment of an exposed positive-working photoresist with the developer causes removal of the exposed areas of the coating and the creation of a positive image in the photoresist coating. Therefore, a desired portion of the underlying surface is uncovered, and the uncovered substrate is thereafter subjected to an etching process. Frequently this involves a plasma etching against which the photoresist coating must be sufficiently stable. The photoresist coating protects the covered areas of the substrate from the etchant and thus the etchant is only able to etch the uncovered areas of the substrate. Thus, a pattern can be created on the substrate which corresponds to the pattern of the mask or template that was used to create selective exposure patterns on the coated substrate prior to development.

Positive working photoresist compositions are currently favored over negative working resists because the former generally have better resolution capabilities and pattern transfer characteristics. Photoresist resolution is defined as the smallest feature which the resist composition can transfer from the photomask to the substrate with a high degree of image edge acuity after exposure and development. In many manufacturing applications today, photoresist resolution on the order of less than one micron is necessary. In addition, it is almost always desirable that the developed photoresist wall profiles be near vertical relative to the substrate. Such demarcations between developed and undeveloped areas of the resist coating translate into accurate pattern transfer of the mask image onto the substrate. This becomes even more critical as the push toward miniaturization reduces the critical dimensions on the devices.

As semiconductor devices continue to become smaller and more miniaturized, the ability to reproduce very small dimensions is extremely important. As the integration degree of semiconductor devices becomes higher, finer photoresist film patterns are required. This has lead to the use of new photoresists that are sensitive to lower wavelengths of radiation and has also led to the use of sophisticated multilevel systems to overcome difficulties associated with such miniaturization.

The optimally obtainable microlithographic resolution is essentially determined by the radiation wavelengths used for the selective irradiation. However, the resolution capacity that can be obtained with conventional deep UV microlithography has its limits. In order to be able to sufficiently resolve optically small structural elements, wavelengths shorter than typical UV radiation must be utilized. The use of deep UV radiation has been employed for many applications, particularly radiation with wavelengths of 248 or 193 nm. However, many photoresist materials that are used today lack transparency at 157 nm, and are therefore not suitable for 157 nm lithography. See, for example, U.S. Pat. No. 5,821,036 which describes a method of making positive photoresists and polymer compositions for use therein. The polymer compositions disclosed therein are non-transparent and unusable in 157 nm lithographic applications. U.S. Pat. No. 6,124,074 discloses acid catalyzed positive photoresist compositions that are transparent to 193 nm radiation but are not transparent to 157 nm radiation. U.S. Pat. No. 6,365,322 discloses photoresist compositions for deep UV irradiation that are also non-transparent to 157 nm radiation.

The reason why photoresists typically lack transparency at 157 nm is because the high absorbance of many organic functional groups at 157 nm makes it difficult to develop an organic polymer that is both base soluble and has low absorbance at 157 nm. Traditional photoresist polymers contain either phenols or carboxylic acids to solubilize the base polymer. Both organic groups, phenols and carboxylic acids, impart an excess of absorbance to the polymeric resist material to allow the polymer to be an effective component of a photoresist for 157 nm lithography. More specifically, known materials based on phenolic resins as a binding agent, particularly novolak resins or polyhydroxystyrene derivatives have too high an absorption at wavelengths below 200 nm and one cannot image through films of the necessary thickness. This high absorption, for example at 193 nm radiation, results in side walls of the developed resist structures which do not form the desired vertical profiles. Rather, they have an oblique angle with the substrate that causes poor optical resolution characteristics at these short wavelengths.

Attempts have been made to produce fluorinated polymers that are substantially transparent to light at the 157 nm wavelength. For example, PCT WO 00/67072 describes fluorinated polymers, photoresists and associated processes for microlithography in which their polymers and photoresists are comprised of a fluoroalcohol functional group which imparts high ultraviolet transparency and which can be developed in basic media. U.S. Pat. No. 6,468,712 teaches resist materials including a photoacid generator and a fluorinated polymer having a protecting group that is labile in the presence of an acid. U.S. Pat. No. 6,486,282 teaches cyano containing polymers for photoresist compositions having at least one non-aromatic cyclic unit. Each of these materials are described as having UV transparency to radiation at the 157 nm wavelength. However, while these materials may exhibit transparency to 157 nm radiation, they do not exhibit other desirable properties such as good resistance to plasma etchants, adhesion to a wide range of substances and surfaces and exceptional mechanical properties in 157 nm lithography applications.

The present invention overcomes these problems in the related art. The present invention describes the preparation of novel fluorinated polymers, as well as novel fluorinated monomers for making such polymers, and methods of using such polymers, particularly in 157 nm photoresists. Typical monomers used in the preparation of polymeric photoresists have an acid labile group, such as a tert-butyl group. The function of this group is to change the solubility of the photoresist polymer when a photoacid generator component of the photoresist produces an acid upon irradiation. In the presence of the acid, the t-butyl group is cleaved, producing hydrolysis products that are soluble in aqueous base. However, while low optical density is necessary for 193 and 157 nm resists, the t-butyl group increases the overall optical density of the resist. Therefore, there is a need to have acid labile functionalities that contribute minimally to optical density, especially at 193 and 157 nm. Other acid labile groups that serve the same function as the t-butyl group include methoxymethyl and ethoxymethyl groups. These groups can be attached to pendant alcohol functions and can be used as a solubility switching device for acidic alcohols, thus eliminating the need for a highly absorbing carbonyl group. However, the precursors used in the preparation of these materials are toxic. Accordingly, the present invention provides novel monomeric esters for photoresists wherein the alcohol portion of the ester has the formula —OC(CH₃)₂CF₃. Such photoresists have reduced optical density while maintaining the essential function of an acid labile group, i.e. upon treatment with acid, the ester is hydrolyzed, producing hydrolysis products that are soluble in an aqueous base. The photoresist materials of the invention exhibit good etch resistance, adhesion to a wide range of substances and surfaces and excellent mechanical properties in 157 nm lithography applications.

### DETAILED DESCRIPTION OF THE INVENTION

The invention provides a compound having the structure:
CR¹R²=CR³—Y—C(O)OC(CH₃)₂CF₃
where R¹ is H, F or part of a norbornene structure linked to R³; R² is H or F; R³ is H, F, CF₃ or part of a norbornene structure linked to R²; y is a nil or a spacer group which comprises an alkylene or fluorinated alkylene moiety of 1-5 carbons; and wherein Y does not contain a hydroxyl group.

The invention also provides a polymer which comprises at least one member which member comprises an acid labile group of the formula —OC(CH₃)₂CF₃.

The invention further provides a photoresist composition comprising:
(a) at least one polymer which comprises at least one member which member comprises an acid labile group of the formula —OC(CH₃)₂CF₃;
(b) at least one photoacid generator in an amount sufficient to generate sufficient acid to remove said acid labile group upon exposure to actinic radiation; and
(c) a solvent capable of dissolving the polymer and the photoacid generator; wherein said polymer is present in the photoresist composition in an amount sufficient to form a uniform film of the composition components when it is coated on a substrate and dried.

The invention still further provides a process for producing an etch resistant image on a substrate, which comprises:
(a) coating and drying a photoresist composition onto a substrate, which photoresist composition comprises:
   (i) at least one polymer which comprises at least one member which member comprises an acid labile group of the formula —OC(CH₃)₂CF₃; and
   (ii) at least one photoacid generator in an amount sufficient to generate sufficient acid to remove said acid labile group upon exposure to actinic radiation;
(b) imagewise exposing the photoresist composition to sufficient activating energy to cause the photoacid generator to generate sufficient acid to decompose the polymer in the imagewise exposed areas of the photoresist composition; and
(c) developing the photoresist composition to thereby remove the imagewise exposed non-image areas and leaving the imagewise unexposed image areas of the photoresist composition.

The invention also provides a microelectronic device image produced by a process which comprises:
(a) coating and drying a photoresist composition onto a substrate, which photoresist composition comprises:
   (i) at least one polymer which comprises at least one member which member comprises an acid labile group of the formula —OC(CH₃)₂CF₃; and
   (ii) at least one photoacid generator in an amount sufficient to generate sufficient acid to remove said acid labile group upon exposure to actinic radiation;
(b) imagewise exposing the photoresist composition to sufficient activating energy to cause the photoacid generator to generate sufficient acid to decompose the polymer in the imagewise exposed areas of the photoresist composition; and
(c) developing the photoresist composition to thereby remove the imagewise exposed non-image areas and leaving the imagewise unexposed image areas of the photoresist composition.

The first step of the process according to the invention is coating and drying a photoresist composition of the invention onto a substrate. The photoresist compositions of the invention are composed of a mixture of at least one water insoluble, acid decomposable polymer which is derived from at least one monomer which has an acid labile group of the formula —OC(CH₃)₂CF₃ and which is substantially transparent to ultraviolet radiation at a wavelength of about 157 nm, at least one photoacid generator capable of generating an acid upon exposure to sufficient activating energy at a wavelength of about 157 nm, and optionally other ingredients.

It has been unexpectedly found that the following novel monomers or compounds of the invention may be used to produce novel polymers useful in forming photoresists having transparency to radiation at the 157 nm wavelength as well as exceptional properties in 157 nm lithography applications, such as good resistance to plasma etchants, adhesion to a wide range of substances and surfaces and excellent mechanical properties. The monomers of the invention are monomeric esters wherein the alcohol portion of the ester has the formula —OC(CH₃)₂CF₃. Such compounds are described by the structure:
CR¹R²=CR³—Y—C(O)OC(CH₃)₂CF₃
where R¹ is H, F or part of a norbornene structure linked to R³; R² is H or F; R³ is H, F, CF3 or part of a norbornene structure linked to R²; Y is a nil or a spacer group which comprises an alkylene or fluorinated alkylene moiety of 1-5 carbons; and wherein Y does not contain a hydroxyl group.

Preferred monomers include acrylates and norbornenes having the —OC(CH₃)₂CF₃ group. Particularly preferred are acrylate compounds having the formula: CX₂=CRC(O)OC(CF₃)(CH₃)₂, wherein X is H or F, and R is X or CF₃. For example, one novel acrylate compound of the invention that has been found to be particularly useful for forming photoresists useful for 157 nm lithography is the compound 2-trifluoromethyl acrylic acid 2,2,2-trifluoro-1,1-dimethyl ethyl ester, which has the following structure:

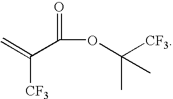

Also particularly preferred are norbornene compounds having the formula: 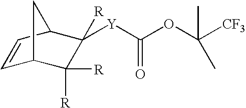
wherein R is F, H or fluoroalkyl, and wherein Y is nil, 0, or a spacer group which comprises (CH₂)ₙ or (CF₂)ₙ wherein n is from 1 to about 5. For example, a novel norbornene compound of the invention useful for 157 nm photoresists lithography is the compound 3-trifluoromethyl-bicyclo[2.2.1]hept-5-ene-2-carboxylic acid-2,2,2-trifluoro-1,1-dimethyl-ethyl ester, which has the following structure:

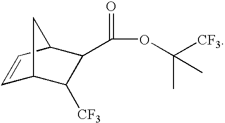

Another novel norbornene compound of the invention useful for 157 nm photoresists lithography is the compound bicyclo[2.2.1]hept-5-ene-2-carboxylic acid 2,2,2-trifluoro-1,1-dimethyl-ethyl ester, which has the following structure:

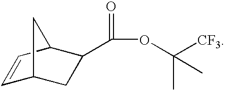

These three specific compounds described above have been found to be particularly desirable in the production of 157 nm photoresists.

The monomers of the invention are used to form polymers having at least one member which member comprises an acid labile group of the formula —OC(CH₃)₂CF₃. In the preferred embodiment of the invention, the polymers of the invention are homopolymers or copolymers which are derived from at least one compound of the invention having the structure:
CR¹R²=CR³—Y—C(O)OC(CH₃)₂CF₃
where R¹ is H, F or part of a norbornene structure linked to R³; R² is H or F; R³ is H, F, CF3 or part of a norbornene structure linked to R²; Y is a nil or a spacer group which comprises an alkylene or fluorinated alkylene moiety of 1-5 carbons; and wherein Y does not contain a hydroxyl group.

Homopolymers of the invention are preferably derived from about 20 to about 200 repeating units of this compound, more preferably from about 32 to about 40 of such repeating units. Copolymers of the invention are preferably derived from at least one monomer of this compound and at least one other co-monomer, preferably from the group of CF₂=CF₂, CF₂=CFH, CF₂=CH₂, CF₃CF=CH₂, CF₃CH=CHF, fluorinated norbornenes, fluorinated norbornenols and CH₂=CHCH₂C(CF₃)OHCF₂CF=CF₂ Particularly preferred are co-polymers formed by the polymerization of co-monomers of this group with the acrylates or norbornenes described above. This includes copolymers derived from 3-trifluoromethyl-bicyclo[2.2.1]hept-5-ene-2-carboxylic acid-2,2,2-trifluoro-1,1-dimethyl-ethyl ester, 2-trifluoromethyl acrylic acid 2,2,2-trifluoro-1,1-dimethyl ethyl ester and bicyclo[2.2.1]hept-5-ene-2-carboxylic acid 2,2,2-trifluoro-1,1-dimethyl-ethyl ester.

Typically, photoresist polymers are composed of homopolymers or multiple comonomers, each of which brings a desired feature to the polymer. For example, monomers with acid labile groups bring a solubility switch, norbornenes bring etch resistance and the comonomers listed above (i.e., CF2=CF2. etc.) bring transparency. The novel monomers of the invention preferably comprise from about 5% to about 50% by weight of the overall polymer for the photoresist compositions of the invention, more preferably from about 15% to about 40% by weight of the polymer, with the balance comprising other suitable co-monomers. The amount will depend on the solubility characteristics of the other monomers. For example, if one of the monomers is a fluorinated norbornene that has good solubility in a developer solution, then the amount of the monomer having the acid labile group will be lower. However, if one of the monomers, for example, has no solubilizing functional groups, such as a fluorinated ethylene, a higher percentage of the polymer will comprise monomers having the acid labile group.

The relative proportions of such comonomers may be adjusted to tailor the desired features of the final product. The monomers of this invention play a dual role, i.e. they add to etch resistance and provide a solubility switch. To keep transparency high, the norbornene content is preferably low, but if it is too low, the polymer may not have good etch resistance or solubility in a developer. Additionally, the monomers and polymers of the invention have reduced optical density relative to compounds having t-butyl groups as the solubility switch component, while still functioning as the switch. Preferred polymers of the invention also include homopolymers derived from 3-trifluoromethyl-bicyclo[2.2.1]hept-5-ene-2-carboxylic acid-2,2,2-trifluoro-1,1-dimethyl-ethyl ester, 2-trifluoromethyl acrylic acid 2,2,2-trifluoro-1,1-dimethyl ethyl ester and bicyclo[2.2.1]hept-5-ene-2-carboxylic acid 2,2,2-trifluoro-1,1-dimethyl-ethyl ester. Homopolymers according to the invention can also be used for forming films and photoresists sensitive at 193 nm.

In the preferred embodiment of the invention, the polymers have a molecular weight of from about 5000 to about 20000 amu, more preferably from about 5000 to about 10000 amu. The desired molecular weights for the polymers of the invention are sufficiently high that they are neither volatile nor a liquid, but are sufficiently low to ensure that the polymer is soluble in a suitable solvent for the photoresist formulation. Additionally, the polymer must be in the right molecular weight range so that, in the typical processing steps (i.e. photolysis and base wash), it will dissolve in the developer solution.

The photoresist compositions of the invention include at least one polymer of the invention in combination with at least one photoacid generator that generates sufficient acid to remove the acid labile group of the polymer upon exposure to actinic radiation at a wavelength of about 157 nm, and a solvent that is capable of dissolving the polymer and the photoacid generator. The term “photoacid generator” is recognized in the art and is intended to include those compounds which generate acid in response to radiant energy. Preferred photoacid generators for use in the present invention are those that are reactive to deep UV radiation, e.g., to radiant energy having a wavelength equal to or less than 248 nm, and are preferably highly reactive to radiation at 157 nm. The combination of the photoacid generator and polymer should be soluble in an organic solvent. Preferably, the solution of the photoacid generator and polymer in the organic solvent are suitable for spin coating. The photoacid generator can include a plurality of photoacid generators.

The polymer is preferably present in the photoresist composition in an amount sufficient to form a uniform film of the composition components when it is coated on a substrate and dried. The photoacid generator is present in an amount sufficient to generate sufficient acid to remove said acid labile group upon exposure to actinic radiation. More specifically, the polymer is preferably present in the overall photoresist composition in an amount of from about 50% to about 99% based on the weight of the solid, i.e. non-solvent parts of the composition. A more preferred range of polymer would be from about 80% to about 99% and most preferably from about 82% to about 95% by weight of the solid composition parts. The photoacid generator is preferably present in an amount ranging from about 1% to about 50% based on the weight of the solid, i.e., non-solvent parts of the composition. A more preferred range of the photoacid generator would be from about 5% to about 20% by weight of the solid composition parts.

Useful photoacid generators capable of generating an acid upon exposure to sufficient activating energy at a wavelength of about 157 nm include onium compounds such as sulfonium, diazonium and iodonium salts and combinations thereof. Sulfonium salts are described in U.S. Pat. No. 4,537,854. Diazonium salts are described in Light Sensitive Systems, Kosar, J.; John Wiley & Sons, New York, 1965. Iodonium salts are described in U.S. Pat. No. 4,603,101. Particularly preferred onium salts are triphenylsulfonium nonaflate and 5-(trifluoromethyl)-dibenzothiophenium trifluoromethanesulfonate. Also suitable are ammonium salts, 2,6-nitrobenzylesters, 1,2,3-tri(methanesulfonyloxy)benzene, sulfosuccinimides and photosensitive organic halogen compounds as disclosed in Japanese Examined Patent Publication No. 23574/1979 and U.S. Pat. No. 6,468,712.

Examples of diphenyliodonium salts include diphenyliodonium triflate and diphenyliodonium tosylate. Examples of suitable bis(4-tert-butylphenyl)iodonium salts include bis(4-tert-butylphenyl)iodonium triflate, bis(4-tert-butylphenyl)iodonium camphorsulfate, bis(4-tert-butylphenyl)iodonium perfluorbutylate and bis(4-tert-butylphenyl)iodonium tosylate. Suitable examples of triphenylsulfonium salts include triphenylsulfonium hexafluorophosphite, triphenylsulfonium triflate and triphenylsulfonium perfluorobutylate.

In preparing the composition, the polymer and photoacid generator are mixed with a sufficient amount of a solvent composition to form a uniform solution. The solvent is not particularly limited, as long as it is a solvent capable of presenting adequate solubility to the polymer, photoacid-generator and is capable of providing good coating properties. For example, it may be a cellosolve type solvent such as methyl cellosolve, ethyl cellosolve, methyl cellosolve acetate or ethyl cellosolve acetate. Ethylene glycol based solvents such as ethylene glycol monomethyl ether, ethylene glycol monoethyl ether acetate, diethylene glycol monomethyl ether, diethylene glycol dibutyl ether, diethylene glycol and diethylene glycol dimethyl ether (diglyme) are suitable as organic solvents for the photoresist compositions of the invention. Propylene glycol based solvents such as propylene glycol monoethyl ether, propylene glycol monobutyl ether, propylene glycol monomethyl ether acetate, propylene glycol alkyl ether, dipropylene glycol dimethyl ether, propylene glycol monoethyl ether acetate or other propylene glycol alkyl ether acetate can be used. Suitable ester type solvents include butyl acetate, amyl acetate, ethyl butyrate, butyl butyrate, diethyl oxalate, ethyl pyruvate, ethyl-2-hydroxybutyrate, 2-methyl-acetoacetate, methyl lactate or ethyl lactate. Alternatively, alcohols are utilized and include heptanol, hexanol, nonanol, diacetone alcohol or furfuryl alcohol. Examples of suitable ketone solvents include cyclohexanone, cyclopentanone or methylamyl ketone. Ethers useful as solvating agents include methyl phenyl ether or diethylene glycol dimethyl ether. Polar solvents, such as dimethylformamide or N-methylpyrrolidone can also be used. The solvents can be used alone or as combinations of two or more solvents. Typically the solvent is used in an amount of from 1 to 100 times by weight, e.g., 20 to 30 times by weight, relative to the total amount of the solid content of the photoresist composition. The most preferred solvents are butyl acetate, ethylene glycol monoethyl ether acetate, diglyme, cyclopentanone and propylene glycol monomethyl ether acetate.

Suitable substrates onto which the photoresist composition of the invention are applied non-exclusively include silicon, aluminum, lithium niobate, polymeric resins, silicon dioxide, doped silicon dioxide, gallium arsenide, Group III/V compounds, silicon nitride, tantalum, copper, polysilicon, ceramics and aluminum/copper mixtures. Semiconductor substrates are most preferred. Lines may optionally be on the substrate surface. The lines, when present, are typically formed by well known lithographic techniques and may be composed of a metal, an oxide, a nitride or an oxynitride. Suitable materials for the lines include silica, silicon nitride, titanium nitride, tantalum nitride, aluminum, aluminum alloys, copper, copper alloys, tantalum, tungsten and silicon oxynitride. These lines form the conductors or insulators of an integrated circuit. Such are typically closely separated from one another at distances preferably of from about 20 micrometers or less, more preferably from about 1 micrometer or less, and most preferably of from about 0.05 to about 1 micrometer.

The composition may additionally contain additives such as colorants, dyes, antistriation agents, leveling agents, crosslinkers, plasticizers, adhesion promoters, speed enhancers, solvents, acid generators, dissolution inhibitors and non-ionic surfactants. Examples of dye additives that may be used together with the photoresist compositions of the present invention include Methyl Violet 2B (C.I. No. 42535), Crystal Violet (C.I. 42555), Malachite Green (C.I. No. 42000), Victoria Blue B (C.I. No. 44045) and Neutral Red (C.I. No. 50040) in an amount of from about 1.0 to about 10.0 percent, based on the combined weight of the solid parts of the composition. The dye additives help provide increased resolution by inhibiting back scattering of light off the substrate. Anti-striation agents may be used up to about five percent by weight, based on the combined weight of solids. Adhesion promoters which may be used include, for example, beta-(3,4-epoxy-cyclohexyl)ethyltrimethoxysilane; p-methyl-disilane-methyl methacrylate; vinyltrichlorosilane; and gamma-amino-propyl triethoxysilane up to about 4.0 percent by weight based on the combined weight of solids. Speed enhancers that may be used include, for example, picric acid, nicotinic acid or nitrocinnamic acid at up to about 20 percent, based on the combined weight of solids. These enhancers tend to increase the solubility of the photoresist coating in both the exposed and unexposed areas, and thus they are used in applications when speed of development is the overriding consideration even though some degree of contrast may be sacrificed; i.e., while the exposed areas of the photoresist coating will be dissolved more quickly by the developer, the speed enhancers will also cause a larger loss of photoresist coating from the unexposed areas. Non-ionic surfactants that may be used include, for example, nonylphenoxy poly(ethyleneoxy)ethanol; octylphenoxy(ethyleneoxy)ethanol; and dinonyl phenoxy poly(ethyleneoxy)ethanol at up to about 10 percent based on the combined weight of solids.

In the production of the microelectronic device of the present invention, one coats and dries the foregoing photoresist composition on a suitable substrate. The prepared resist solution can be applied to a substrate by any conventional method used in the photoresist art, including dipping, spraying, whirling and spin coating. When spin coating, for example, the resist solution can be adjusted as to the percentage of solids content in order to provide coating of the desired thickness given the type of spinning equipment utilized and the amount of time allowed for the spinning process. In a preferred embodiment of the invention, the photoresist layer is formed by centrally applying a liquid photoresist composition to the upper surface on a rotating wheel at speeds ranging from about 500 to about 6000 rpm, preferably from about 1500 to about 4000 rpm, for about 5 to about 60 seconds, preferably from about 10 to about 30 seconds, in order to spread the composition evenly across the upper surface. The thickness of the photoresist layer may vary depending on the amount of liquid photoresist composition that is applied, but typically the thickness may range from about 500 Angstroms (Å) to about 50,000 Å, and preferably from about 2000 Å to about 12000 Å. The amount of photoresist composition which is applied may vary from about 1 ml to about 10 ml, and preferably from about 2 ml to about 8 ml depending on the size of the substrate.

After the resist composition solution is coated onto the substrate, the substrate is temperature treated at approximately 20° C. to 200° C. This temperature treatment is done in order to reduce and control the concentration of residual solvents in the photoresist while not causing substantial thermal degradation of the photoacid generator. In general one desires to minimize the concentration of solvents and thus this temperature treatment is conducted until substantially all of the solvents have evaporated and a thin coating of photoresist composition, on the order of a micron in thickness, remains on the substrate.

In a preferred embodiment the temperature is conducted at from about 50° C. to about 150° C. A more preferred range is from about 70° C. to about 90° C. This treatment is conducted until the rate of change of solvent removal becomes relatively insignificant. The temperature and time selection depends on the resist properties desired by the user as well as equipment used and commercially desired coating times. Commercially acceptable treatment times for hot plate treatment are those up to about 3 minutes, more preferably up to about 1 minute. In one example, a 30 second treatment at 90° C. is useful. Treatment times increase to about 20 to about 40 minutes when conducted in a convection oven at these temperatures.

After deposition onto the substrate, the photoresist layer is imagewise exposed, such as via a fluorine laser or through a polysilicon etch mask to actinic radiation. This exposure renders the photoresist layer more soluble after exposure than prior to exposure. When such a resist is exposed to light, activated acid induces a catalytic chain reaction to a photoresist film organic polymer, generating a significant amount of protons. In the resist, protons bring a large change into the solubility of the resin. When the photoresist film is irradiated by a high energy beam, e.g. 157 nm, acid (H⁺) is generated, reacting with the polymer. Acid is again generated and reacts with unreacted polymer. The polymer is then dissolved in a developing solution. In contrast, the polymer at the non-exposed region maintains its structure, which is insoluble to the developing solution. With such a mechanism, a good profile pattern can be made on a wafer substrate. The amount of actinic radiation used is an amount sufficient to render the exposed portions of the photoresist layer imagewise soluble in a suitable developer. Preferably, UV radiation is used in an amount sufficient to render the exposed portions of the photoresist layer imagewise soluble in a suitable developer. UV exposure doses are preferably around about 40 mJ/cm². Preferably the process further comprises the step of heating the imagewise exposing the photoresist composition prior to developing, such as by baking, for a sufficient time and temperature to increase the rate at which the acid decomposes the polymer in the imagewise exposed areas of the photoresist composition. This drives the acid reaction for better image formation. Such a heat treatment may be conducted at temperatures of from about 50° C. to about 150° C., preferably from about 120° C. to about 150° C. for from about 30 seconds to about 2 minutes.

The development step may be conducted by immersion in a suitable developing solution, preferably an aqueous alkaline solution. The solution is preferably agitated, for example, by nitrogen burst agitation. The substrates are allowed to remain in the developer until all, or substantially all, of the resist coating has dissolved from the irradiated areas. Typical examples of the aqueous alkaline solutions suitable as the developer include sodium hydroxide, tetramethylammonium hydroxide, or aqueous solutions of hydroxides of metals belonging to the Groups I and II of the periodic table such as potassium hydroxide. Aqueous solution of organic bases free from metal ions such as tetraalkylammonium hydroxide, for example, tetramethylammonium hydroxide (TMAH), tetraethylammonium hydroxide (TEAH) and tetrabutylammonium hydroxide (TBAH). More preferably, tetramethylammonium hydroxide (TMAH) are preferred. Furthermore, if desired, the aqueous basic solution used as the developer may additionally contain any additives such as a surface active agent in order to improve the resulting development effect. After removal of the coated wafers from the developing solution, an optional, although not required, post-development heat treatment or bake may be employed to increase the adhesion of the coating as well as resistance to etching solutions and other substances. The post-development heat treatment can comprise the oven baking of the coating and substrate below the coating's softening point. The result is an patterned image that may be subsequently transformed into a useful device, such as a microelectronic device suitable for forming semiconductors.

The compounds of this invention can be made in a number of ways. For example an acid RCOOH can be reacted with (CH₃)₂CF₃COH or with (CH₃)CF₃C=CH₂ in a process advantageously catalyzed by a strong mineral acid. Alternatively, an acid halide, i.e., RCOCl can be reacted with a metal salt of (CH₃)₂CF₃COH or the acid halide can reacted with the alcohol in the presence of a base. When an alcohol needs to be converted to a material with the (CH₃)₂CF₃CO— group, a carbonate can be prepared. That is, ROH is converted into ROC(O)OC(CF₃)(CH₃)₂. This can be accomplished by reacting either ROH or (CH₃)₂CF₃COH with phosgene to give an alkyl chloroformate, followed by reacting the chloroformate with the other alcohol. Alternatively, the alcohol in some cases can be converted to the ether, ROC(CF₃)(CH₃)₂.

Detailed procedures for making the monomers and polymers of the invention, as well as the preferred method for utilizing the polymers in a photoresist composition for use in microlithography, are described in the following examples.

### EXAMPLE 1

### Preparation of lithium tert-trifluoromethyl butoxide

Trifluoromethyl-t-butanol (40.96 g, 0.32 mole) was dissolved in 100 mL of anhydrous THF and cooled to below 5° C.; n-Butyl lithium (2.5 M in hexane, 128 mL, 0.32 mol) was added at a rate to keep the internal reaction temperature below 5° C. After the addition was complete, the reaction was stirred at room temperature for 1 h to complete the formation of the lithium salt. The conversion was quantitative. The reagent was used directly without further characterization.

### EXAMPLE 2

### Preparation of 3-trifluoromethyl-bicyclo[2.2.1]hept-5-ene-2-carboxylic acid

3-trifluoromethyl-bicyclo[2.2.1]hept-5-ene-2-carboxylic acid ethyl ester (100 g, 0.427 mol) was added to a flask containing NaOH (85 g, 2.12 mol) in 1.5 L of H₂O. The two-phase system was heated at 95° C. for 4 h, after which time, a yellow homogeneous solution resulted. The reaction was cooled to ambient temperature and extracted with hexane (2×100 mL) to remove any remaining organic species. The aqueous phase that resulted from this process was cooled to 5° C., then acidified with 12 N HCl to a pH of 1-2. The white precipitate that formed was filtered, washed with H₂O (100 mL) and dried. The yield of acid was 86.83 g (98%). Melting point=85-90° C. ¹⁹F NMR: −68 ppm (d, J=9.7 Hz,exo) and −66.7 ppm (d, J=9.7 Hz,endo).

### EXAMPLE 3

### Preparation of 3-trifluoromethyl-bicyclo[2.2.1]hept-5-ene-carbonyl chloride

The norbornene acid prepared in Example 2 (75 g, 0.364 mol) was refluxed with thionyl chloride (150 mL, 2.0 mol) for 2.5 h. Excess SOCl₂ was removed by distillation at atmospheric pressure. The product was isolated by vacuum distillation. Yield of colorless liquid was 73.47 g (89.9%), bp 40-43° C./1.0 mm. ¹⁹F NMR: −68.3 ppm (d, J=9.7 Hz,exo); −66.9 ppm (d, J=8.6 Hz,endo).

### EXAMPLE 4

### Preparation of 3-trifluoromethyl-bicyclo[2.2.1]hept-5-ene-2-carboxylic acid-2,2,2-trifluoro-1,1-dimethyl-ethyl ester

The acid chloride prepared in Example 3 was dissolved in THF (50 mL). This solution was cooled to 10° C., then treated with the solution of lithium tert-trifluoromethyl butoxide (40.96 g, 0.32 mol) prepared in Example 1 at an addition rate to maintain the internal reaction temperature below 20° C. After the addition was complete, the formation of LiCl was observed. This mixture was heated for 2 h at 40° C. The reaction mass was cooled to ambient temperature and quenched with H₂O (125 mL). The resulting organic phase was separated, dried with MgSO₄ and the solvents removed by distillation. The product was isolated by vacuum distillation. Yield of colorless liquid was 83.34 g (85%), bp 60-64° C./2 mm. ¹⁹F NMR: −68.1 ppm (d, J=9.7 Hz,exo); −66.8 ppm (d, J=8.6 Hz,endo); −84.4 ppm (s,endo); −84.6 ppm (s, exo).

### EXAMPLE 5

### Preparation of 3-trifluoromethyl-bicyclo[2.2.1]hept-5-ene-2 carboxylic acid tert-butyl ester

The acid chloride prepared in Example 3 (28 g, 0.125 mol) was dissolved in THF (50 mL), cooled to 5° C. and reacted with lithium t-butoxide in hexane (0.125 mol). The butoxide solution was added at a rate to maintained the internal reaction temperature <20° C. After the addition was completed, the solution was heated to 40° C. and maintained at this temperature for 2 h. The work-up procedure was identical to that described in Example 4. Yield of colorless liquid was 29.0 g (88.5%), bp 65-67° C./0.7 mm. ¹⁹F NMR: −66.7 ppm (d, J=8.6 Hz,endo); −68.0 ppm (d, J=9.7 Hz,exo).

### EXAMPLE 6

### Preparation of bicyclo[2.2.1]hept-5-ene-2-carboxylic acid 2,2,2-trifluoro-1,1-dimethyl-ethyl ester

This compound was prepared following the procedure described in Example 4 by reacting bicyclo[2.2.1]hept-5-ene-2-carbonyl chloride (15 g, 0.096 mol) with tert-trifluoromethyl butoxide (0.105 mol). The yield of colorless liquid, was 21.88 g (92%).

### EXAMPLE 7

### Hydrolysis of 3-trifluoromethyl-bicyclo[2.2.1]heptane-2-carboxylic acid 2,2,2-trifluoro-1,1-dimethyl-ethyl ester at room temperature

3-Trifluoromethyl-bicyclo[2.2.1]heptane-2-carboxylic acid 2,2,2-trifluoro-1,1-dimethyl-ethyl ester (0.52 g, 1.60 mmol) was reacted at room temperature with 0.1 g of H₂SO₄ (18 M). After 6 hours, the reaction was quenched with 10 mL of H₂O. The resulting solid was isolated by filtration to yield 0.20 g (60.6%) of 3-trifluoromethyl-bicyclo[2.2.1]heptane-2-carboxylic acid, mp 87-90° C. ¹⁹F NMR: −66.4 ppm (d,J=10.7 Hz,endo); −71.1 ppm (d, J=10.7 Hz,exo). This example shows that esters of CF₃(CH₃)₂COH are readily hydrolyzed in the presence of an acid, even at room temperature.

### EXAMPLE 8

### Hydrolysis of 3-trifluoromethyl-bicyclo[2.2.1]heptane-2-carboxylic acid 2,2,2-trifluoro-1,1-dimethyl-ethyl ester at 70° C.

This was a repeat of Example 7, except that the reaction temperature was maintained at 70° C. for 2 h. The yield of 3-trifluoromethyl-bicyclo[2.2.1]heptane-2-carboxylic acid was 0.31 g (94%), mp 87-90° C.

A general procedure for the preparation of polymers of the monomers of this invention is as follows:

A catalyst solution is prepared by mixing, in an inert atmosphere, allylpalladium chloride dimer and silver hexafluorantimonate in a molar ratio of about 1:2 to 1:3 (typically 1:2.5). To this mixture is added deoxygenated dichloroethane and the mixture is stirred for about 30 minutes. The result is a slurry of dissolved allyl Pd(SbF₆)₂ dimer and insoluble AgCl. The solution is then filtered through a 0.45 micron PTFE filter to remove the AgCl to give a clear catalyst solution.

The monomer is dissolved in 1,2-dichloroethane or other suitable solvent. The solution is stirred and purged with nitrogen to deoxygenate the system for 30 minutes prior to adding the catalyst. The catalyst is then added and a nitrogen purge is continued for an additional 15 minutes prior to placing it under a nitrogen blanket. The reaction mixture is stirred at room temperature for a total of about 2-24 h, during which time an increase in viscosity may be observed. The amounts of catalyst and monomer, relative to solvent, typically result in a solution that is 0.5 to 5 wt % catalyst and 5-30 wt % percent monomer (typically 20 wt %). After the desired reaction period, the nitrogen blanket is removed and air is bubbled through the solution for 1 hour. Ethanol is added to the reaction flask to dilute the polymer. The solution is filtered through a 0.2 micron PTFE filter, and water is then added to the solution to precipitate the polymer. The polymer is finally filtered and dried.

### EXAMPLE 9

### Homopolymerization of bicyclo[2.2.1]hept-5-ene-2-carboxylic acid 2,2,2-trifluoro-1,1-dimethyl-ethyl ester

To a 50 mL 3-neck round bottom flask equipped with a Teflon® coated stir bar, septum inlet, and a reflux condenser was added 1,2dichloroethane (3.9 mL) and bicyclo[2.2.1]hept-5-ene-2-carboxylic acid 2,2,2-trifluoro-1,1-dimethyl-ethyl ester (2 g, 7.78 mmol). To this stirred solution at ambient temperature was added a catalyst solution prepared by reacting η³-allyl palladium chloride dimer (28.5 mg, 0.08 mmol) with silver hexafluoroantimonate (53.5 mg, 0.156 mmol) in 1,2dichloroethane (3 mL) for 30 minutes followed by filtration through a 0.45 micron filter. The reaction was allowed to run for 18 hours at which time the solvent was flashed off and the remaining polymer was dried at 80° C. under vacuum. The yield of the homopolymer was 1.9 g (95%). The molecular weight of the homopolymer was determined to be 9161 g/mole (MW) with a polydispersity of 2.0 (GPC in THF, polystyrene standards). Thermogravimetric analysis (TGA) under nitrogen (heating rate of 10° C./minute) showed the polymer to be thermally stable to 200° C.

### EXAMPLE 10

### Copolymerization of bicyclo[2.2.1]hept-5-ene-2-carboxylic acid 2,2,2-trifluoro-1,1-dimethyl-ethyl ester and 2-bicyclo[2.2.1]hept-5-en-2-ylmethyl-1,1,1,3,3,3-hexafluoropropan-2-ol

To a 50-mL, 3-neck roundbottom flask equipped with a Teflon® coated stir bar, septum inlet, and a reflux condenser was added 1,2-dichloroethane (3.9 mL), bicyclo[2.2.1]hept-5-ene-2-carboxylic acid 2,2,2-trifluoro-1,1-dimethyl-ethyl ester (1 g, 3.89 mmol), and 2-bicyclo[2.2.1]hept-5-en-2-ylmethyl-1,1,1,3,3,3-hexafluoropropan-2-ol (1.07 g, 3.89 mmol). To this stirred solution at ambient temperature was added a catalyst solution prepared by reacting η³-allyl palladium chloride dimer (28.5 mg, 0.08 mmol) with silver hexafluoroantimonate (53.5 mg, 0.156 mmol) in 1,2dichloroethane (3 mL) for 30 minutes and then filtering through a 0.45 micron filter. The reaction was allowed to run for 18 hours at which time the solvent was flashed off and the remaining polymer was dried at 80° C. under vacuum. The yield of the copolymer was 2.0 g (96.5%). The molecular weight of the copolymer was determined to be 10734 g/mole (MW) with a polydispersity of 2.2 (GPC in THF, polystyrene standards). Thermogravimetric analysis (TGA) under nitrogen (heating rate of 10° C./minute) showed the polymer to be thermally stable to 200° C.

Data for homopolymers and copolymers are summarized in the following Table:

TABLE 1

| COPOLYMER DATA FOR CF₃-T-BUTYL | | | | | |
|---|---|---|---|---|---|
| COMPOUNDS | | | | | |
| Monomer A | Monomer B | Conditions | Tg or Tm | Yield | MW |
| 3-trifluoromethyl- | none | 70° C.; 1% Pd(SbF₆)₂ | 126° C. | 40% | 4631 |
| bicyclo[2.2.2]hept-5-ene- | | | | | |
| carboxylic acid 2,2,2- | | | | | |
| trifluoro-1,1-dimethyl | | | | | |
| ethyl ester | | | | | |
| 3-trifluoromethyl- | 5-fluoro-6-trifluoromethyl- | 1:1 mole ratio; RT; | | 36% | 4057 |
| bicyclo[2.2.2]hept-5-ene- | bicyclo{2.2.2]hept-2-ene | 1% Pd(SbF₆)₂ | | | |
| carboxylic acid 2,2,2- | | | | | |
| trifluoro-1,1-dimethyl | | | | | |
| ethyl ester | | | | | |
| 3-trifluoromethyl- | 5-fluoro-6-trifluoromethyl- | 1:1 mole ratio; 70° C.; | | 75% | |
| bicyclo[2.2.2]hept-5-ene- | bicyclo{2.2.2]hept-2-ene | 1% Pd(SbF₆)₂ | | | |
| carboxylic acid 2,2,2- | | | | | |
| trifluoro-1,1-dimethyl | | | | | |
| ethyl ester | | | | | |
| 3-trifluoromethyl- | 5,5-difluoro-6-trifluoromethyl- | 1:1 mole ratio; RT; | | 30% | 3226 |
| bicyclo[2.2.2]hept-5-ene- | bicyclo[2.2.1]hept-2-ene | 1% Pd(SbF₆)₂ | | | |
| carboxylic acid 2,2,2- | | | | | |
| trifluoro-1,1-dimethyl | | | | | |
| ethyl ester | | | | | |
| 3-trifluoromethyl- | | 1:1 mole ratio; 70° C.; | | 42% | |
| bicyclo[2.2.2]hept-5-ene- | | 1% Pd(SbF₆)₂ | | | |
| carboxylic acid 2,2,2- | | | | | |
| trifluoro-1,1-dimethyl | | | | | |
| ethyl ester | | | | | |
| 3-trifluoromethyl- | 2-bicyclo[2.2.1]hept-5- | 1:1 mole ratio; RT; | | 59% | 8137 |
| bicyclo[2.2.2]hept-5-ene- | en-2-ylmethyl-1,1,1,3,3,3-hexa- | 1% Pd(SbF₆)₂ | | | |
| carboxylic acid 2,2,2- | fluoropropan-2-ol | | | | |
| trifluoro-1,1-dimethyl | | | | | |
| ethyl ester | | | | | |
| | | 1:1 mole ratio; 70° C.; | | 72% | |
| 3-trifluoromethyl- | 2-bicyclo[2.2.1]hept-5- | 1% Pd(SbF₆)₂ | | | |
| bicyclo[2.2.2]hept-5-ene- | en-2-ylmethyl-1,1,1,3,3,3-hexa- | | | | |
| carboxylic acid 2,2,2- | fluoropropan-2-ol | | | | |
| trifluoro-1,1-dimethyl | | | | | |
| ethyl ester | | | | | |
| 3-trifluoromethyl- | 2-trifluoromethyl acrylic | 1:1 mole ratio; 85° C.; | | | |
| bicyclo[2.2.2]hept-5-ene- | acid t-butyl ester | 5% AIBN | | | |
| carboxylic acid 2,2,2- | | | | | |
| trifluoro-1,1-dimethyl | | | | | |
| ethyl ester | | | | | |
| Bicyclo[2.2.2]hept-5-ene- | none | RT; 1% Pd(SbF₆)₂ | Tg = 109° C. | 95% | 9161 |
| carboxylic acid 2,2,2- | | | Tm = 176° C. | | |
| trifluoro-1,1-dimethyl | | | | | |
| ethyl ester | | | | | |
| Bicyclo[2.2.2]hept-5-ene- | 2-bicyclo[2.2.1]hept-5-en- | 1:1 mole ratio; RT; | | 97% | 10734 |
| carboxylic acid 2,2,2- | 2-ylmethyl-1,1,1,3,3,3-hexa- | 1% Pd(SbF₆)₂ | | | |
| trifluoro-1,1-dimethyl | fluoropropan-2-ol | | | | |
| ethyl ester | | | | | |
| Bicyclo[2.2.2]hept-5-ene- | 5-fluoro-6-trifluoromethyl- | 1:1 mole ratio; RT; | Tg = 150° C. | 70% | 3792 |
| carboxylic acid 2,2,2- | bicyclo{2.2.2]hept-2-ene | 1% Pd(SbF₆)₂ | | | |
| trifluoro-1,1-dimethyl | | | | | |
| ethyl ester | | | | | |
| Bicyclo[2.2.2]hept-5-ene- | 5-fluoro-6-trifluoromethyl- | 1:1 mole ratio; 70° C.; | Tg = 135° C. | 70% | |
| carboxylic acid 2,2,2- | bicyclo{2.2.2]hept-2-ene | 1% Pd(SbF₆)₂ | | | |
| trifluoro-1,1-dimethyl | | | | | |
| ethyl ester | | | | | |
| Bicyclo[2.2.2]hept-5-ene- | 5,5-difluoro-6-trifluoromethyl- | 1:1 mole ratio; RT; | Tg = 145° C. | 45% | 3979 |
| carboxylic acid 2,2,2- | bicyclo[2.2.1]hept-2-ene | 1% Pd(SbF₆)₂ | | | |
| trifluoro-1,1-dimethyl | | | | | |
| ethyl ester | | | | | |
| Bicyclo[2.2.2]hept-5-ene- | 2-trifluoromethyl acrylic | 1:1 mole ratio; 85° C.; | | | |
| carboxylic acid 2,2,2- | acid t-butyl ester | 5% AIBN | | | |
| trifluoro-1,1-dimethyl | | | | | |
| ethyl ester | | | | | |

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto.

What is claimed is:

1. A compound having the structure:
CR¹ R²=CR³—Y—C(O)OC(CH₃)₂CF₃
where R¹ is H, F or part of a norbornene structure linked to R³; R² is H or F; R³ is H, F, CF₃ or part of a norbornene structure linked to R²; Y is a nil or a spacer group which comprises an alkylene or fluorinated alkylene moiety of 1-5 carbons; and wherein Y does not contain a hydroxyl group.

2. A compound of claim 1 which comprises an acrylate having the formula:
CX₂=CRC(O)OC(CF₃)(CH₃)₂,
wherein X is H or F, and R is X or CF₃.

3. The compound of claim 1 which comprises a norbornene having the structure: 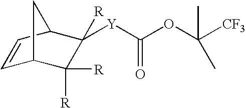
wherein R is F, H or fluoroalkyl; wherein Y is nil, or a spacer group which comprises an alkylene or fluorinated alkylene moiety of 1-5 carbons; and wherein Y does not contain a hydroxyl group.

4. The compound of claim 1 having the structure 3-trifluoromethyl-bicyclo[2.2.1]hept-5-ene-2-carboxylic acid-2,2,2-trifluoro-1,1-dimethyl-ethyl ester.

5. The compound of claim 1 having the structure 2-trifluoromethyl acrylic acid 2,2,2-trifluoro-1,1-dimethyl ethyl ester.

6. The compound of claim 1 having the structure bicyclo[2.2.1]hept-5-ene-2-carboxylic acid 2,2,2-trifluoro-1,1-dimethyl-ethyl ester.

7. A polymer which comprises at least one member which member comprises an acid labile group of the formula —OC(CH₃)₂CF₃.

8. The polymer of claim 7 which has a molecular weight of from about 5000 to about 20000 amu.

9. The polymer of claim 7 which comprises a homopolymer or copolymer which is derived from said at least one member, wherein said at least one member comprises a compound having the structure:
CR¹R²=CR³—Y—C(O)OC(CH₃)₂CF₃
where R¹ is H, F or part of a norbornene structure linked to R³; R² is H or F; R³ is H, F, CF₃ or part of a norbornene structure linked to R²; Y is a nil or a spacer group which comprises an alkylene or fluorinated alkylene moiety of 1-5 carbons; and wherein Y does not contain a hydroxyl group.

10. The polymer of claim 7 which is substantially transparent to ultraviolet radiation at a wavelength of 157 nm.

11. The polymer of claim 7 which comprises a homopolymer that is derived from about 20 to about 200 repeating units of said at least one member.

12. The polymer of claim 7 which comprises a homopolymer that is derived from about 32 to about 40 repeating units of said at least one member.

13. The polymer of claim 7 which comprises a copolymer which is derived from said at least one member and further derived from at least one co-member, which co-member is selected from the group consisting of CF₂=CF₂, CF₂=CFH, CF₂=CH₂, CF₃CF=CH₂, CF₃CH=CHF, fluorinated norbornenes, fluorinated norbornenols, and CH₂=CHCH₂C(CF₃)OHCF₂CF=CF₂.

14. The polymer of claim 13 wherein said at least one member comprises an acrylate having the formula:
CX₂=CRC(O)OC(CF₃)(CH₃)₂
wherein X is H or F, and R is X or CF₃.

15. The polymer of claim 13 wherein said at least one member comprises a norbornene having the structure: 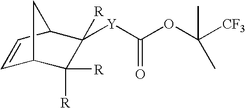
wherein R is F, H or fluoroalkyl; wherein Y is nil, or a spacer group which comprises an alkylene or fluorinated alkylene moiety of 1-5 carbons; and wherein Y does not contain a hydroxyl group.

16. The polymer of claim 7 which comprises a homopolymer or a copolymer which is derived from said at least one member, wherein said at least one member comprises an acrylate having the formula:
CX₂=CRC(O)OC(CF₃)(CH₃)₂
wherein X is H or F, and R is X or CF₃.

17. The polymer of claim 7 which comprises a homopolymer or a copolymer which is derived from said at least one member, wherein said at least one member comprises a norbornene having the structure: 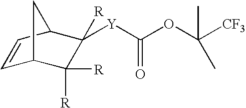
wherein R is F, H or fluoroalkyl; wherein Y is nil, or a spacer group which comprises an alkylene or fluorinated alkylene moiety of 1-5 carbons; and wherein Y does not contain a hydroxyl group.

18. The polymer of claim 7 which comprises a homopolymer or a copolymer which is derived from said at least one member, wherein said at least one member comprises a compound having the structure:

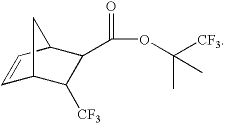

19. The polymer of claim 7 which comprises a homopolymer or a copolymer which is derived from said at least one member, wherein said at least one member comprises a compound having the structure:

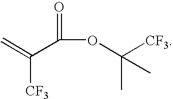

20. The polymer of claim 7 which comprises a homopolymer or a copolymer which is derived from said at least one member, wherein said at least one member comprises a compound having the structure:

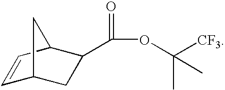

21. A photoresist composition comprising:
(a) at least one polymer which comprises at least one member which member comprises an acid labile group of the formula —OC(CH₃)₂CF₃;
(b) at least one photoacid generator in an amount sufficient to generate sufficient acid to remove said acid labile group upon exposure to actinic radiation; and
(c) a solvent capable of dissolving the polymer and the photoacid generator; wherein said polymer is present in the photoresist composition in an amount sufficient to form a uniform film of the composition components when it is coated on a substrate and dried.

22. The photoresist composition of claim 21 wherein the polymer is substantially transparent to ultraviolet radiation at a wavelength of about 157 nm, and wherein the photoacid generator generates sufficient acid to remove said acid labile group upon exposure to actinic radiation at a wavelength of about 157 nm.

23. The photoresist composition of claim 21 wherein said polymer comprises at least one member which member comprises an acid labile group of the formula —OC(CH₃)₂CF₃.

24. The photoresist composition of claim 21 wherein said polymer comprises at least one member which member comprises an acid labile group of the formula —OC(CH₃)₂CF₃, which polymer has a molecular weight of from about 5000 to about 20000 amu.

25. The photoresist composition of claim 21 wherein said polymer comprises a copolymer which is derived from said at least one member, wherein said at least one member comprises a compound having the structure:
CR¹R²=CR³—Y—C(O)OC(CH₃)₂CF₃
where R¹ is H, F or part of a norbornene structure linked to R³; R² is H or F; R³ is H, F, CF3 or part of a norbornene structure linked to R²; Y is a nil or a spacer group which comprises an alkylene or fluorinated alkylene moiety of 1-5 carbons; and wherein Y does not contain a hydroxyl group.

26. The photoresist composition of claim 21 wherein said polymer comprises a copolymer which is derived from said at least one member and further derived from at least one co-member, which co-member is selected from the group consisting of CF₂=CF₂, CF₂=CFH, CF₂=CH₂, CF₃CF=CH₂, CF₃CH=CHF, fluorinated norbornenes, fluorinated norbornenols, CH₂=CHCH₂C(CF₃)OHCF₂CF=CF₂.

27. The photoresist composition of claim 21 wherein said at least one member comprises an acrylate having the formula:
CX₂=CRC(O)OC(CF₃)(CH₃)₂
wherein X is H or F, and R is X or CF₃.

28. The photoresist composition of claim 21 wherein said at least one member comprises a norbornene having the structure: 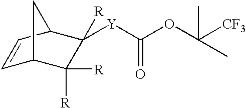
wherein R is F, H or fluoroalkyl; wherein Y is nil, or a spacer group which comprises an alkylene or fluorinated alkylene moiety of 1-5 carbons; and wherein Y does not contain a hydroxyl group.

29. The photoresist composition of claim 21 wherein said polymer comprises a copolymer which is derived from said at least one member, wherein said at least one member comprises an acrylate having the formula:
CX₂=CRC(O)OC(CF₃)(CH₃)₂
wherein X is H or F, and R is X or CF₃.

30. The photoresist composition of claim 21 wherein said polymer comprises a copolymer which is derived from said at least one member, wherein said at least one member comprises a norbornene having the structure: 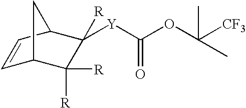
wherein R is F, H or fluoroalkyl; wherein Y is nil, or a spacer group which comprises an alkylene or fluorinated alkylene moiety of 1-5 carbons; and wherein Y does not contain a hydroxyl group.

31. The photoresist composition of claim 21 wherein said polymer comprises a copolymer which is derived from said at least one member, wherein said at least one member comprises a compound having the structure:

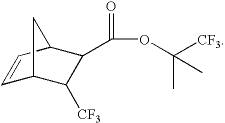

32. The photoresist composition of claim 21 wherein said polymer comprises a copolymer which is derived from said at least one member, wherein said at least one member comprises a compound having the structure:

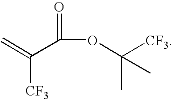

33. The photoresist composition of claim 21 wherein said polymer comprises a copolymer which is derived from said at least one member, wherein said at least one member comprises a compound having the structure:

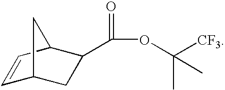

34. The photoresist composition of claim 21 which photoacid generator comprises an onium compound.

35. The photoresist composition of claim 21 wherein the photoacid generator comprises a sulfonium, iodonium or diazonium compound or combinations thereof.

36. The photoresist composition of claim 21 wherein said solvent is selected from the group consisting of butyl acetate, ethylene glycol monoethyl ether acetate, diglyme, cyclopentanone and propylene glycol monomethyl ether acetate.

37. The photoresist composition of claim 21 wherein said polymer is present in the photoresist composition in an amount of from about 50% to about 99% and the photoacid generator is present in an amount of from about 1% to about 50% based on the weight of the non-solvent parts of the photoresist composition.

38. A process for producing an etch resistant image on a substrate, which comprises:
(a) coating and drying a photoresist composition onto a substrate, which photoresist composition comprises:
(i) at least one polymer which comprises at least one member which member comprises an acid labile group of the formula —OC(CH₃)₂CF₃; and
(ii) at least one photoacid generator in an amount sufficient to generate sufficient acid to remove said acid labile group upon exposure to actinic radiation;
(b) imagewise exposing the photoresist composition to sufficient activating energy to cause the photoacid generator to generate sufficient acid to decompose the polymer in the imagewise exposed areas of the photoresist composition; and
(c) developing the photoresist composition to thereby remove the imagewise exposed non-image areas and leaving the imagewise unexposed image areas of the photoresist composition.

39. The process of claim 38 wherein the polymer is substantially transparent to ultraviolet radiation at a wavelength of about 157 nm, and wherein the photoacid generator generates sufficient acid to remove said acid labile group upon exposure to actinic radiation at a wavelength of about 157 nm.

40. The process of claim 38 wherein the photoresist composition is exposed to activating energy at a wavelength of about 157 nm.

41. The process of claim 38 wherein the substrate is selected from the group consisting of silicon, aluminum, lithium niobate, polymeric resins, silicon dioxide, doped silicon dioxide, gallium arsenide, Group III/V compounds, silicon nitride, tantalum, copper, polysilicon, ceramics and aluminum/copper mixtures.

42. The process of claim 38 wherein the exposing is conducted with a fluorine laser.

43. The process of claim 38 wherein the developing is conducted with an aqueous alkaline solution.

44. The process of claim 38 further comprising the step of heating the exposed photoresist composition prior to developing for a sufficient time and temperature to increase the rate at which the acid decomposes the polymer in the imagewise exposed areas of the photoresist composition.

45. A microelectronic device image produced by a process which comprises:
(a) coating and drying a photoresist composition onto a substrate, which photoresist composition comprises:
(i) at least one polymer which comprises at least one member which member comprises an acid labile group of the formula —OC(CH₃)₂CF₃; and
(ii) at least one photoacid generator in an amount sufficient to generate sufficient acid to remove said acid labile group upon exposure to actinic radiation;
(b) imagewise exposing the photoresist composition to sufficient activating energy to cause the photoacid generator to generate sufficient acid to decompose the polymer in the imagewise exposed areas of the photoresist composition; and
(c) developing the photoresist composition to thereby remove the imagewise exposed non-image areas and leaving the imagewise unexposed image areas of the photoresist composition.
